(19) United States
(12) Patent Application Publication
(10) Pub. No.: US 2020/0234206 A1
(43) Pub. Date: Jul. 23, 2020

(54) System and Methods for Assessing and Analyzing Security Risk of a Physical Infrastructure

(71) Applicant: Joseph Rietman, Chicago, IL (US)

(72) Inventor: Joseph Rietman, Chicago, IL (US)

(21) Appl. No.: 16/250,739

(22) Filed: Jan. 17, 2019

(51) Int. Cl. G06Q 10/06

(52) U.S. Cl. CPC G06Q 10/0635; G06Q 10/06393

(57) ABSTRACT

A method for assessing and analyzing a security risk of one or more assets within physical infrastructure. The method comprises of analyzing each and every security asset of the infrastructure; calculating an IKE score for each asset based on certain pre-defined criteria; determining the security risk of one or more of the assets based on the IKE score; performing a gap analysis to minimize the risk of one or more of the assets; and presenting the gap analysis and analyzed results to an owner of the infrastructure.

### RELATED APPLICATION

The present application claims the filing benefit of U.S. Provisional Application No. 62/635,130 for a System and Methods for Assessing and Analyzing Security Risk of a Physical Infrastructure.

### TECHNICAL FIELD OF THE INVENTION

The present application relates to a security assessment system. Particularly, the application relates to a system and methods for assessing and analyzing a risk of one or more assets within a physical infrastructure and presenting risk control measures.

### BACKGROUND OF THE INVENTION

In today's environment where organizations and infrastructures can be under multiple threats at the same time, whether it be real or virtual, safety and security is of utmost importance to any company, corporation or organization. Many owners of such companies choose to bring in personnel such as security experts to help assess the threat and provide reasonable suggestions and advice regarding the prevailing security threats. However, even though the personnel may be called a security expert, there has in the past been no consistent framework available to the experts which would have enabled them to determine in an objective form, the nature of the security risks an organization faced, given an objective quantification of the threats the organization was under and the security measures which had been taken. Moreover, much of the security risk management advice has been based on the experience, common sense and subjective expertise of the practitioner or expert being utilized. In other words, there has been no consistent methodology or objective means from which the experts can base their opinion off of. Owners frequently request more objective decision-making support from their experts, requests articulated in terms of asking for the “Return on Investment” of a proposed security expenditure or asking for an objective financial measure of the benefit of proposed or deployed security measures. Practitioners' or assessors inability to produce such objective figures prevents the owners from having a reliable and accurate assessment of their present security risks, of how those risks are changing from month to month, and of the expected effects and benefits of the security efforts or expenditures they might make. Furthermore, utilizing opinions over factual and regimented scoring systems leads an organization to a false sense of security.

As a result there is a need to address such shortcomings by providing a more standardized process, that is applicable to a variety of infrastructures and gives the owners a good assessment of where security is lacking, what measures need to be taken to achieve fault proof security and what the return on investment will be for implementing proposed security measures, all utilizing a more consistent and objective methodology.

### Statement of Objectives

Embodiments of the present invention provide a quantitative detailed process for identifying, prioritizing, and estimating risks by analyzing physical vulnerability information to determine the extent to which such vulnerabilities can impact the physical security of a system, and presenting options to mitigate such vulnerabilities.

An object of the invention is that it provides a facility owner a quantifiably accurate, unbiased, and consistent analysis of existing or proposed gaps in a physical protection system.

A further object of the invention is to break down item by item each and every component of the physical security infrastructure and determine where each such component is lacking in meeting security needs.

Another object of the invention is the understanding and validation of performance of specific components through performance testing.

Still another object is to standardize the level of protection obtained by the application of a multiple layered security systems against a particular aggressor/adversary.

Still another objective of the invention is to provide a detailed gap analysis report detailing what measures need to be lessen the gap between current measures and future proposed measures taken to improve security.

Still another objective of the invention is to provide an accurate return on investment with incorporating the proposed security measures.

Other objects and advantages of the present invention will be set forth in part in the description and in the drawings that follow and, in part, will be obvious from the description or may be learned by practice of the invention.

### SUMMARY OF THE INVENTION

There is disclosed herein a system and methods for assessing and analyzing security risk of a physical infrastructure which avoids the disadvantages of prior systems and methods white affording additional structural and operating advantages.

To achieve the foregoing objects, and in accordance with the purpose of the invention as broadly described herein, the present invention provides systems and methods for assessing physical security and providing contra measures for minimizing chances of breach.

It will be appreciated from the description of the systems and methods and that they may be used in many environments and made in many embodiments. As used herein, the present invention provides a detailed process for identifying, prioritizing, and estimating risks by analyzing physical threat and vulnerability information to determine the extent to which circumstances or events could adversely impact a physical asset. Several inventive embodiments of the present invention are described below.

In one embodiment of the invention, a method for analyzing a security risk of one or more assets within physical infrastructure is provided comprising: analyzing each and every security asset of the infrastructure; calculating an IKE score for each asset based on certain pre-defined criteria; determining the security risk of one or more of the assets based on the IKE score; performing a gap analysis to minimize the risk of one or more of the assets; and presenting the gap analysis and analyzed results to an owner of the infrastructure.

In one embodiment of the invention, each and every component of the invention to be analyzed further includes Perimeter Barrier Security, Camera Security, Sensor Security, Lighting Systems and Analytics and Assessment System.

In another embodiment of the invention the IKE score provides a standardized measure of security assessment.

In yet another embodiment of the invention the IKE score is determined by points accorded according to meeting pre-defined criteria.

In yet another embodiment of the invention the pre-defined criteria has been determined via thorough research and analysis of relevant security systems.

In a further embodiment of the invention full points or a certain percentage points are accorded depending on how strong or weak the asset protection is.

In a further embodiment of the invention the assessor analyzes each and every security asset by on-site visits.

In yet another embodiment of the invention the gap analysis gives a detailed analysis of the ideal IKE score to attain the best return on investment for the owner's infrastructure security.

The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

These and other aspects of the invention may by understood more readily from the following description and appended drawings.

### BRIEF DESCRIPTION OF THE DRAWINGS

For the purpose of facilitating and understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a flow chart showing the six main steps for the IKE Certification Process in accordance with one embodiment of the invention.

FIG. 2 is a flow chart depicting the main security components to be assessed in an embodiment of the invention.

FIG. 3 is a flow chart showing the system characterization process in accordance with one embodiment of the invention.

FIG. 4 is a diagram showing IKE scoring for the Protective Barrier System (PBS).

FIG. 5 is a diagram showing the IKE scoring for the Electronic Sensor System (ESS).

FIG. 6 is a diagram showing the IKE scoring for the Lighting System (LS).

FIG. 7 is a diagram showing the IKE scoring for the Camera System (CS).

FIG. 8 is a diagram showing the IKE scoring for the Assessment and Analytics System (AAS).

FIG. 9 is a flow chart showing the system characterization process in accordance with another embodiment of the invention.

FIG. 10 is a diagram showing the current versus proposed system investment and related IKE scores.

FIG. 11 is a diagram showing the IKE current score assessment.

FIG. 12 is a diagram showing the IKE future score assessment.

### DETAILED DESCRIPTION OF THE PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

The present invention is implemented in a system and process called IKE Physical Protection System Certification. IKE PPS certification is a method for scoring by calculating the likelihood and characteristics of security breaches as a function of the measured security threats and the countermeasures deployed. Moreover, owner refers to the owner of the physical infrastructure being assessed, and may incorporate many aspects of the team that an assessor may come into contact with including management, stake holders, shareholders etc. Assessors refers to security experts and term assessors, security experts, professionals and practitioners may be used interchangeably to refer to the same personnel.

The scoring system follows the principles of security that restrict physical access to unauthorized personnel in controlled areas by utilizing a system of barriers, lighting, cameras, electronic sensors and detectors, and analytic and assessment platforms in a comprehensive physical security package. Understanding that physical security risks are only mitigated and not eliminated, the user/owner must implement overlapping layers of security components that complement each other and contribute in one fashion or another to achieving an effective defense in depth plan.

The present invention will now be described with respect to various embodiments, including analyzing the complete current system, applying the IKE system certification to each asset and component of the presently analyzed system, computing the total IKE score for all assets, presenting the current IKE score and current system investment to the owners, and lastly presenting a gap analysis document, along with the return on investment with implementing the proposed measures.

Each and every embodiment of the invention will be described more in detail now.

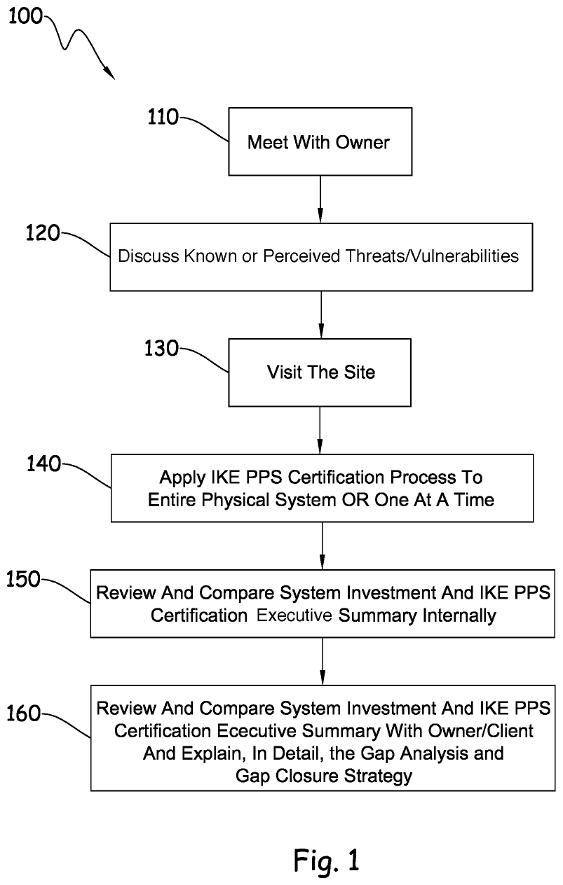

Referring now to the figures, FIG. 1 depicts a flow chart showing the six main steps of the IKE PPS certification process 100, in accordance with one embodiment of the present invention. The IKE certification process consists of these six main steps done through-out the life cycle of the assessment: Step 1 110 Meet with owner, Step 2 120 discuss perceived threats/vulnerabilities, Step 3 130 visit the site, Step 4 140 Apply IKE PPS certification process to entire physical system OR one at a time, Step 5 150 Review and compare System Investment and IKE PPS Certification Executive Summary Internally, and Step 6 160 Review and compare System Investment and IKE PPS Certification Executive Summary with Owner/Client and explain, in detail the Gap Analysis and Gap Closure Strategy. These steps will be described in more detail below.

Generally, an assessor or security personnel will analyze the whole site before moving onto scoring, but for purposes of ease of explanation it is assumed that the assessor is analyzing each component/asset (Perimeter Barriers, Lighting, Cameras, Sensors and Analytics and Assessment) individually and moving onto scoring for each such component. This will be described more in detail below.

Step 1, 110 includes meeting with the owner initially. Before beginning the actual IKE PPS certification Assessment, an assessor must query the responsible physical security planner, director or owner to establish a foundational understanding of their design, intent and response parameters. Further, during this face to face meeting several points are discussed 120, related to any known vulnerabilities or current threats. The assessor may ask the owner a few key questions including, but not limited to current measures in place to challenge unfamiliar personals, as well as measures in place to counter criminal acts. Further the personnel can also query any law enforcement agencies to query whether there is any information sharing taking place between such agencies and owners in case of any criminal activity taking place.

Once the initial queries have been answered by the owner the professional then moves on to discuss any perceived threats or vulnerabilities that the owner or any other personnel in charge, may be aware of 120. In doing so the certification professional may also look at historical trends, for example a few inquiries to be asked from a site security manager may be:

a. Do security managers actively monitor certain reports of crime within a set radius of the facility?
b. Do security managers consider surrounding area crime rates, locations, and times of offense, in periodic re-assessment of security plans?

Furthermore, the assessor may also look into inquiring what the current security strategy is and whether such a strategy provides ample deterrence to potential intruders. The assessor may also ask pointed questions regarding the current protective barriers in place, any electronic sensors that may be installed, what type of lighting is in use, how effective the cameras are, the analytical capabilities of the cameras, etc.

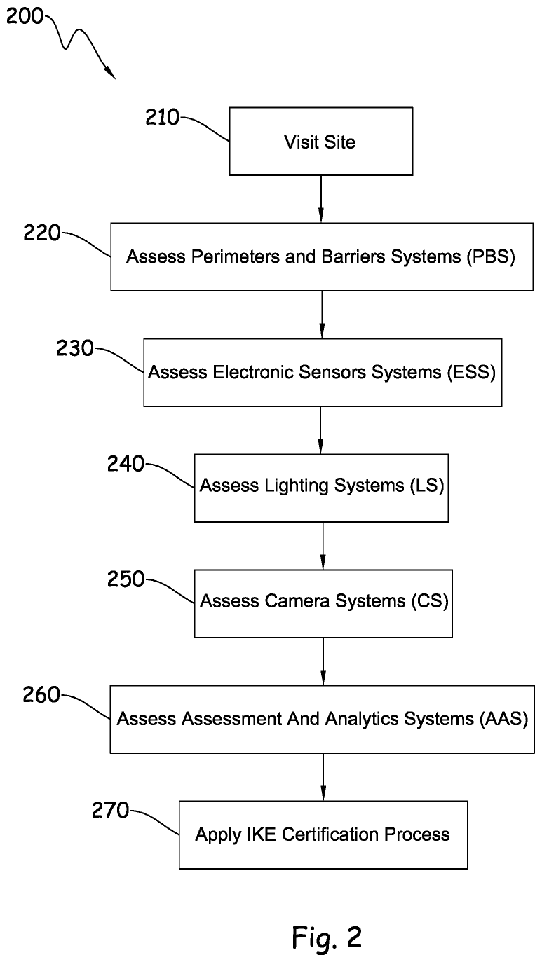

Once an accurate determination has been made of any known vulnerabilities and or threats known to the owners/supervisors, by asking incisive questions related to all components above, the next step is then to visit the actual site 130. This is also described more in detail in FIG. 2.

Moving onto FIG. 2, upon visiting the actual site 210 the assessor analyzes each and every component of the site security, these include but are not limited to analyzing the perimeters and barriers (PBS) 220, electronic sensors system (ESS) 230, lightning system (LS) 240, camera system (CS) 250, and the analytics and assessment system (AAS) 260. We will now look at how the analysis and then IKE scoring takes place for each and every component individually.

On site, the professional can analyze the protective barrier systems 220 present on the site.

A well-designed Protective Barrier System (PBS) is the first overt sign of a protected facility or area. Barriers are designed to restrict, channel, or impede access in addition to defining the boundaries of the facility. They are designed to deter the worst-case threat and also serve as a legal demarcation. Any attempt by an adversary to breach the barrier is a demonstration of intent and purpose. Additionally, a barrier system serves as an essential element of an owner's ability to safeguard the public and a physical demarcation beyond which improperly protected persons could be subject to injury or death from the activities, hardware, or materials contained within the enclosed area. Regardless, the PBS should be focused on providing assets within the protected facility with an acceptable level of protection against the threat.

Protective barriers consist of two major categories—natural and structural.

Natural protective barriers are mountains and deserts, cliffs and ditches, water obstacles, or other terrain features that are difficult to traverse.

Structural protective barriers are man-made devices (such as fences, walls, gates, grills, bars, cables, bollards and other construction) used to restrict, channel, or impede access.

Barriers offer important benefits to a physical-security posture. They create a psychological deterrent for anyone thinking of unauthorized entry. They may delay or even prevent passage through them. This is especially true of barriers against forced entry and vehicles. Barriers have a direct impact on the number of security personnel required, as well as delay and response times.

Some considerations to consider when determining the barrier types would be barrier design considerations, i.e. how much of the facility the barrier encloses; barrier ratings i.e. the vehicle barrier resistance; types of barriers and barrier systems which may be perimeter barriers, fencing, walls, gates etc., and any fixed or dynamic barriers etc.

When conducting a preliminary analysis of PBS 220 the intent to be met is to restrict, impede, deter and/or delay an adversary to improve security response. To do this some requirements to be met by the PBS are:

a. PBS must be interconnected with the electronic security systems, cameras, and assessment and analytics platforms.
b. Each layer must provide 360 degrees of protection, unless the facility Design Input Document or physical security plan dictates otherwise.
c. Each PBS will be scored independently (e.g. a double-layer expanded metal fence constructed with a chain link no-man's land would be three separate PBS)

Furthermore, PBS fencing must be:

a. At least 7 ft high
b. Bottom of fabric or fence panel must not be higher than 1 inch from the ground
c. All bolts and hardware that would facilitate the uninstallation must be peened.
d. All pedestrian and vehicle gates must meet the same structural standards as the adjacent PSB.
e. All perimeter encumbrances (utility openings, drainage culverts, manholes, etc.) must have grills or bars installed.

Once a preliminary analysis of the whole site is done by the professional, the professional can now do a detailed analysis by utilizing the IKE PPS certification process to this asset or security component 140. This is done by starting off with IKE scoring. For Perimeter Barrier Security the three main aspects to be scored will be Perimeter Barrier Area, Vehicle Barriers and Specialty Barriers.

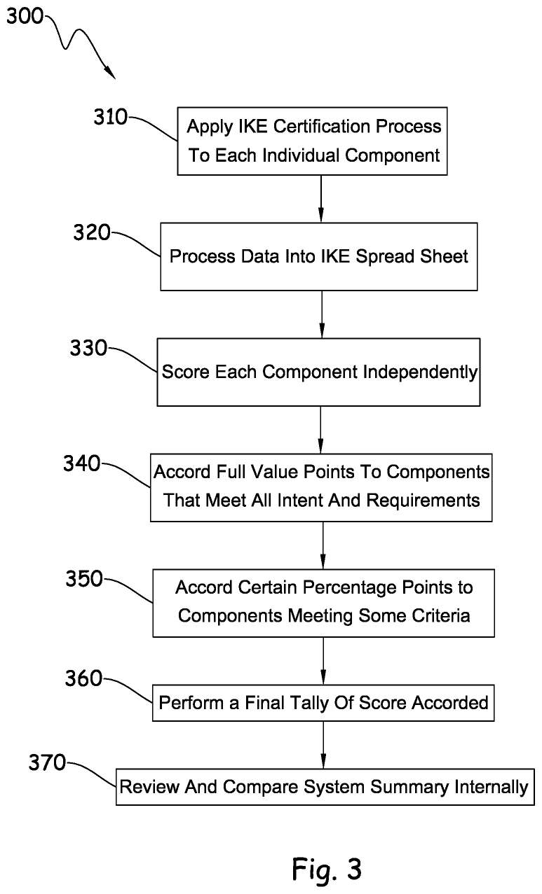

Moving onto FIG. 3, the IKE certification process is applied to each component 310 in this instance starting with the perimeter barrier area. Further it will be determined if full points are to be given 340 or certain percentage points are given 350 as mentioned below. For scoring the perimeter barrier area the following methodology is applied:

a. Each area (layer) will be scored independent of all other areas (layers).
b. Full point value will be assessed for each area (layer) that meets the intent and all requirements, based upon the number and type of PBS employed within the area.
c. One or more PBS employed in an area (layer) that do(es) not meet the 360-degree protection requirement (if directed) will receive credit for the percentage of the circle of protection that is provided (e.g. One PBS assessed at 12 points and another PBS assessed at 8 points, together provide only 70% of the 360 degree protection would result in 70% of the 20 point aggregate or 14 points).
d. A 10% point reduction penalty will be assessed for each inch or portion of an inch greater than 1-inch the fence fabric is above the average ground level.
e. A fence height less than 4-feet receives no credit. Every foot under 7-feet will be assessed a 25% point penalty. Every foot over 7-feet will be assessed a 25% point addition.
f. Each gate or man-passable perimeter encumbrance meeting the requirements will result in a 2% point penalty reduction for the aggregate score for that particular PBS (e.g. aggregate score is 12.4 points and has three gate openings resulting in a 6% point reduction for a new point value of 11.7 points).
g. Each gate or man-passable perimeter encumbrance not meeting the requirements will result in a 25% point penalty reduction for the aggregate score for that particular PBS (e.g. aggregate score is 11.7 points and has one gate opening without a top-guard resulting in a 25% point reduction for a new point value of 8.8 points).

Next, the personnel will apply the IKE certification 310 to the vehicle barrier requirements. For the requirements of barrier vehicle the following criteria must be met:

a. PBS must be interconnected with the electronic security systems, cameras, and assessment and analytics platforms.
b. Each vehicle barrier must meet the level of protection dictated by the facility Design Input Document or physical security plan.
c. Full point value will be assessed for each system that meets all intent and requirements and designed and employed as described in the base document.

Then scoring will be accorded 330 as an example the following points will be accorded to perimeter vehicle barriers: Aircraft cable—5, jersey barriers 5, permanent bollard 2.

Furthermore, it has to be determined how to accord value points, full value 340, or a certain percentage of the total value 350. For full point value, the vehicle barrier must meet a certain rating standard, in this instance it will be the M30/K4 rating. Vehicle barriers meeting M30/K4 rating will be accorded full point value. Additional Vehicle Resistance Ratings will be assessed as a percentage point increase or penalty based upon the rating.

For full point value, the vehicle barrier must meet a certain depth of penetrating rating, in this instance it will be the P1 depth of penetration rating. Additional penetration ratings will be assessed as a percentage point decrease based upon the rating

a. Perimeter Vehicle Barrier Systems are scored as a percentage of the entire perimeter they cover (e.g. Aircraft Cable valued at 5 points covering 50% of the perimeter would result in 2.5 points.)
b. Each Approach Route is scored independent of other routes.
c. Approach Route Channeling Barriers and Serpentine Obstacles will be assessed a point value based upon the percentage of the route that the barrier system(s) covers (e.g. Total length of a route is 500 feet, with 250 feet of the route employing an Aircraft Cable channel barrier on both sides of the route. Aircraft Cable is valued at 6 points but only 50% of the route has this system resulting in a total assessed value of 3 points.)
d. Point Barriers are assessed their point value no matter where they are employed on the route.

Next an assessor would move onto applying the IKE certification to the specialty barrier rating 310 which will measure the effectiveness of specialty barriers employed at a specific facility.

The requirements in this instance will be:

a. Specialty barrier must be interconnected with the electronic security systems, cameras, and assessment and analytics platforms
b. Each specialty barrier must meet the level of protection or obscuration dictated by the facility Design Input Document or physical security plan (UL752 or NIJ ballistic protection and/or percentage of obscuration viewed from a set distance).
c. Each specialty barrier element must have engineered wind-load testing.

Moving onto scoring 330, full 340, or a certain percentage point 350, will be accorded as such:

a. Full point value will be assessed for each specialty barrier system that meets all intent and requirements and is designed and employed as described in the base document.
b. For Critical Asset Obscuration, each asset within the facility that is designated by the Design Input Document and/or facility physical security plan for obscuration, the point value (4 points) for the Obscuration Specialty Barrier will be assessed against the number of sides the critical asset is covered with each side valued at 25% and a bonus value of an additional 25% for the top (e.g. A critical asset component is obscured on three sides will result in a value of 75% of 4 points, or 3 points.)
c. For Perimeter Obscuration, the point value (8 points) for the Obscuration Specialty Barrier will be assessed as a percentage of the total perimeter that is obscured (e.g. A perimeter that is composed of concrete panels, expanded metal, or a design specific fabric mesh panel affixed to the fence that surrounds 80% of a facility will result in 80% of 8 points, or 6.4 points assessed for the barrier.)
d. For Critical Asset Ballistic Protection, each asset within the facility that is designated by the Design Input Document and/or facility physical security plan for ballistic protection, the point value as indicated below for each NIJ Level of ballistic protection will be assessed against the number of sides the critical asset is covered with each side valued at 25% and a bonus value of an additional 25% for the top (e.g. A critical asset component has ballistic protection of NIJ Level IIIA on three sides will result in a value of 75% of 4 points, or 3 points.) The lowest level of ballistic protection on each asset will be the value used in assessment.
e. For Perimeter Ballistic Protection, the point value as indicated below for each NIJ Level of protection will be assessed as a percentage of the total perimeter that is protected (e.g. A perimeter that is composed of concrete panels exceeding NIJ Level IV protection that surrounds 80% of a facility will result in 80% of 8 points, or 6.4 points assessed for the barrier.)
f. NIJ Level ratings: NIJ Level I-1, NIJ Level IMIA-2, NIJ Level III-IIIA-4, NIJ Level IV-6, Exceeds NIJ Level IV-8.

Once all the points are accorded to each individual component, the assessor then tally's the score for each component 360 to accord a final IKE score to the Perimeter barrier Security 220 as stated in FIG. 2.

Back to FIG. 2, the next component to be analyzed are the Electronic Sensors Systems 230. An Electronic Sensor System (ESS) and its associated components are yet another critical element of a facility's complete physical security system. When well designed, planned, implemented, and maintained, and ESS provides early warning of a potential threat—either on approach or as the threat is at a barrier or crossing a protected area. This system consists of hardware and software elements operated and maintained by trained security personnel. The system is configured to provide one or more layers of detection around a protected facility. Each layer is made up of a series of contiguous detection zones designed to isolate the facility and to control the access and egress of authorized personnel and materials. An ESS consists of sensors connected to a control module that automatically assesses information and annunciates an alarm (both visually and audibly) and is interconnected with other elements of the physical security system such as lighting, cameras, and assessment and analytic software. Ultimately, the situation must be assessed by trained security personnel to make a determination to send security personnel or law enforcement.

While analyzing the ESS, assessor wants to make sure the following security requirements are met:

a. ESS must be interconnected with the barrier plan, lighting, cameras, and assessment and analytics platforms.
b. Each layer must provide 360 degrees of protection, unless the facility Design Input Document or physical security plan dictates otherwise.

Upon making a determination of the security requirements, the assessor can then move into the IKE certification process, FIG. 3, 310. Scoring is accorded as such—330-350:

a. Each area (layer) will be scored independent of all other areas (layers).
b. Full point value will be assessed for each area (layer) that meets the intent and all requirements, based upon the number and type of ESS employed within the area.
c. One or more ESS employed in an area (layer) that do(es) not meet the 360 degree protection requirement (if directed) will receive credit for the percentage of the circle of protection that is provided (e.g. One ESS assessed at 12 points and another ESS assessed at 8 points, together provide only 70% of the 360 degree protection would result in 70% of the 20 point aggregate or 14 points).

Next up lighting systems (LS) 240 would be analyzed. Security lighting is an essential element of an integrated physical security program and allows security personnel to maintain visual-assessment capability during periods of limited visibility. Properly designed and implemented security lighting systems may offer the additional benefit of acting as psychological deterrent to the spectrum of threat directed at a particular facility or site. When or where security lighting is impractical or impaired, additional security measures must be employed to offset risk.

Some terms used in lighting terms and their definitions are as follows:

Illuminance. Defined as the intensity of illumination incident on a surface area stated in terms of “foot-candles” or “lux,” which are not equivalent measurements. One foot-candle (f-c) is defined as the intensity of illumination on a 1-square-foot surface from a 1-lumen source of light located 1 foot away. One lux is the international system of units (SI) standard unit (metric) for illuminance, defined as the illumination on a 1-square-meter surface from a 1-lumen source located 1 meter away. One f-c is equal to 10.76 lux. For ease of conversion, industry practice uses 10 as the conversion factor between unit systems (i.e., 1 f-c=10 lux).

Illumination. Occurs either naturally or artificially. Natural illumination emanates from the sun, moon, and stars. Artificial illumination is manmade and comes from an illumination source such as a luminaire.

Reflectance. Defined as the percentage of light reflected from a scene, depending on the angle of the light incident on the surface of a scene and on the texture and composition of the reflecting surface. A scene becomes visible when illumination is reflected from surfaces and objects within that scene. Reflectance is determined by measuring illuminance with a light meter's sensor facing down, divided by the illuminance measurement with the light meter facing upward. (The measurement should be made such that neither the light meter nor the person making the measurements create a shadow on the sensor when face up or on the ground just below the light sensor when face down.) For natural illumination, the reflectance of various scenes is relatively independent of the angles of incidence and reflection.

Light-to-Dark Ratio. Defined as the contrast of the illuminance of an object or threat actor against the illuminance of the background or terrain expressed figuratively as X:X, where X is represented as a number. The “evenness” (also referred to as “flatness” or “uniformity”) of scene illumination enhances the ability to assess intruder location. Tests have shown that lighting designs with at least a 6-to-1 (6:1) light-to-dark ratio at the end of bulb life provide sufficient illumination evenness for assessment purposes.

Periods of Limited Visibility. Defined as any naturally or man-made environmental situation where naturally-occurring sources of light are minimized or non-existent. Routinely, nighttime is the primary period of limited visibility but may similar periods may exist during in daytime during intense rain, snow, or dust storms. Dense fog may also induce a period of limited visibility against which lighting is ineffective and may actual degrade the ability of the naked eye or optical sensors to see.

For LS, an assessor will be assessing three different components and criteria: Lamp type and reactivity, Lighting coverage and facility reflectance. The requirements for each type are now described.

For lamp type and reactivity, the lamps must provide the necessary illumination to contribute the facility's overall physical security posture. Reactive Lighting must provide sufficient illumination of an alarmed zone to determine the nature of the event or object causing the alarm.

The requirements for the lamps must be as such:

a. Lamps must meet the illumination requirements of the video assessment system, alarm assessment, and security personnel.
b. The lamp must provide the most advantageous illumination speed, cost, longevity, and color spectrum for the video assessment system employed on the site.
c. Lighting may be continuous or stand-by (automatic or manual).
d. The lighting must have an on-command capacity for activation (manual directed).
e. Lighting must be immediate for initial illumination and within ten (10) seconds for restrike.
f. Lighting must cover the perimeter and critical aspects of the interior area as established in the physical security plan for the facility or site,

For applying the IKE certification and scoring, 310-350, the following criteria is taken into consideration:

a. There are a total of ten (10) points available for a lamp that meets the intent and requirements a-b, as follows by type: Incandescent-10, Quartz Iodine 10, LED Output 8, Fluorescent Mercury Vapor 7, HID 9
b. There are a total of ten (10) additional points available for lighting reactivity that meets the intent and requirements c-f.
c. A 25% point reduction penalty will be assessed for each minute, or portion thereof, the lighting system takes to achieve full output.
d. A 25% point reduction penalty will be assessed for each minute, or portion thereof, beyond 10 seconds, the lighting system takes to restrike and achieve full output.
e. Resultant values by lamp-type and reactivity will be assessed against what ratio they represent compared to the total number of lamps on site to arrive at the final score.
f. Score will not be reduced further than zero (0).

The assessor then analyzes the second component in LS 230 lighting coverage. For lighting coverage the assessor analyzes the perimeters and areas illuminated to make sure they must match those under surveillance. Further points to be analyzed include:

a. The entirety of the perimeter (360 degrees) must be illuminated on-demand or continuously.
b. The entirety of the perimeter (360 degrees) must have shock lighting illuminating out to 100 meters beyond the Area 3 perimeter, on-demand or continuously.
c. The entirety of the interior area must be illuminated, on-demand or continuously.
d. Lighting system must meet the minimum Imager Illumination requirements proscribed by the camera manufacturer with on-site verification.

IKE certification process is then applied 310 and scoring is conducted as follows, FIG. 3, 320-350:

a. There are a total of twenty-five (25) points available for a lighting system that meets the intent and all requirements (10 points for perimeter lighting, 5 points for shock lighting, and 10 points for area lighting).
b. A total of ten (10) points will be assessed against the percentage of perimeter covered (e.g. 10 points×83% coverage=8.3 points).
c. A total of five (5) points will be assessed against the percentage of 100 meter—expanded perimeter is covered (e.g. 5 points×75% coverage=3.75 points).
d. A total of ten (10) points will be assessed against the percentage of interior area covered (e.g. 10 points×65% coverage=6.5 points).
e. An additional 10% of points in each category above (b-d) will be added for lighting systems that are integrated with an Assessment & Analytics platform that automatically command initiates lighting based upon threat detection.
f. Point values will added together to arrive at the total point value for Lighting Coverage.

The third component of Lighting System 230 is facility reflectance which is a characteristic of a Lighting System that defines how much of the area under observation is designed and maintained to provide optimal background material reflectance.

An assessor analyzes this system to make sure the following requirements are present:

a. The entirety of the perimeter (including 25 feet or 8 meters either side of the perimeter) must be designed and maintained to provide maximum reflectance
b. The entirety of the interior area (including dead space) must be designed and maintained to provide maximum reflectance.
c. The perimeter 25-meters to the interior and exterior of the outer barrier, and the entire interior area, must cleared of vegetation or vegetation maintained to no more than 6 inches in height.

IKE certification process and scoring of this component is then conducted, 310-350, as follows:

a. There are a total of twenty (20) points available for facility reflectance that meets the intent and all requirements (10 points for perimeter and 10 points for area).
b. Points for ground material reflectance for materials used adjacent the perimeter and in the interior areas will be assessed as follows: Gray concrete—10; Sand or grey rounded or crushed rock—9, grass—7, Asphalt—4.
c. Ten (10) points will be assessed against the percentage of perimeter composed of each background material of uniform reflectance (e.g. 83% of the perimeter has gray crushed rock for background=9 points×83% coverage=7.47 points).
d. A penalty of the percentage of perimeter not meeting requirement c will be assessed against the point aggregate in scoring c above (e.g. 7.47 points×15% of perimeter with vegetation=6.35 points).
e. A 5% point reduction penalty will be assessed against the aggregate of area points for each facility in the interior area that is not constructed of gray concrete or painted to a higher reflectance (e.g. two buildings are red brick indicating a 20% point reduction on 6.98 points=resulting in 6.28 points).
f. The aggregate of resultant perimeter and area point values will be the assessed Facility Reflectance score.

Moving on, the assessor then conducts and assessment of the camera systems (CS) 260. Stand-alone cameras or camera systems that are not integrated to an assessment or alarm activation system or subject to constant monitoring, provide negligible value to a physical security system. Conversely, a properly selected and integrated camera system is key to an effective assessment and analytics system (further described below) that provides a rapid and cost-effective method for determining the cause of intrusion alarms. For camera systems designed for surveillance, a properly selected and implemented camera system provides a cost-effective supplement to guard patrols. A comprehensive camera system is more easily justified for larger facilities and can mitigate manpower requirements that would otherwise be dedicated to perimeter patrols. At sites where electronic perimeter or interior electronic detection systems are employed, a camera system is a necessary component of the overall physical security system—regardless of site size—to help interrogate alarm causal factors, and if necessary, to generate a response.

For cameras, an assessor determines that the following requirements should be met during the preliminary analysis:

a. Camera must be connected to a monitoring and/or assessment system.
b. Camera must have hard-wired or wireless connectivity to the monitor and/or assessment system. (Wiring and/or wireless connection must have a secure signal, resistant to hacking or unauthorized viewing by those other than intended.)
c. Camera must have redundant or temporary power back-up.
d. Camera must be capable of operating in the temperature and environmental extremes posed by seasonal averages throughout the year.

The assessor then moves onto the IKE certification and scoring process, 310-350, and points are accorded as follows:

a. Cameras will be grouped by type and quantity as single type or combinations of camera types including Black & White, Color, Day/Night, and/or Thermal cameras.
b. The point values for each camera are as follows: Black/white cameras—2, color cameras—5, Day/night cameras: 8, thermal cameras—12.
c. For each camera type, the aggregate point value will be assessed against the percentage of perimeter and/or area the camera type covers (e.g. a camera system with a Color (5 points) and Thermal (12 points) capability that covers 75% of the perimeter would be assessed 12.75 points).
d. The point total in scoring step C will be reduced by 50% for any system that is not hardened or secured.
e. The point total in scoring step C will be reduced by 50% for any system that is not connected to a redundant power supply.
f. If the system is neither hardened or secured and is not connected to a redundant power supply, a point value of zero will be assessed for that camera type.
g. The total of points aggregated in steps c thru f will be divided by the total quantity of camera systems in all the types. This result will be the IKE PPS CERTIFICATION assessed.

Next up, an assessor analyzes the Assessment and Analytics system 260. A well designed and implemented Video System is a critical component of the means to assess potential threats and is equally important to the initiation of a response. At its core, these systems provide a means to determine the necessary actions or responses necessary to mitigate situations that pose a challenge to site or facility security. The key element within the assessment process is identification. Identification assists the security force in selecting appropriate responses within a force continuum to address security-related and potential threat situations resulting from the detected activity. Equally important, identification provides a means for the security force to determine the absence of a threat resulting from detected activity such as a nuisance alarm caused by wildlife or debris. It is equally important that the assessment techniques identify the stimulus that caused the alarm quickly, before the stimulus of the alarm disappears from view. This enables the initiation of timely response consistent with the goals and objectives of the physical protection program and protective strategy. Therefore, video assessment systems should be robust and capable of providing the highest level of protection for the specific application for which they are employed. The assessment and analytics system comprise three components: Cameras, automated object interrogation and bandwidth and playback.

For cameras assessment every camera system should be employed in a manner so as to take advantage of all of its analytical capabilities.

An assessor analyzes the system to ensure the following requirements are met with regards to cameras:

a. Camera must have a zoom capability of at least 10×.
b. Camera must have at least a detect capability.
c. Cameras must have Video Motion Detection capability.

The assessor then moves onto applying the IKE certification process and scoring 310-350, FIG. 3, using the following methodology:

a. There are a total of four (4) points available at the beginning for the presence of a camera system.
b. A 100% point reduction penalty will be assessed for any camera or camera in a system without zoom.
c. A 75% point reduction penalty will be assessed for any camera or camera in a system with a zoom less than 10×.
d. A 25% point addition will be assessed for any camera or camera in a system with a zoom of 25× or greater but less than or equal to 100×.
e. A 75% point addition will be assessed for any camera or camera in a system with a zoom of greater than 100×.
f. The following points will be added to the existing point total for camera resolution: Detect—3, Classify—6, identify—8.
g. The following points will be added to the existing point total for Video Motion Detection capabilities: Slew to cue—6, tracking—10, PTZ only—1.5, No hands off—7.5
i. PTZ points added only if there isn't an automated Slew-to-Cue capability.
ii. No Hand-Off points will be added if the system Tracks automatically but will not automatically hand-off to another camera.

The next component to be assessed under AAS analysis 270 is Automated object interrogation. Automated object interrogation is Assessment of a system that automatically categorizes information received from an array of systems as a threat or non-threat event, and activates physical security components from other systems.

The assessor analyzes the automated object interrogation to see if it meets the following requirements:

a. The system must be connected to all available components in the physical security system.
b. The software algorithm must categorize an event based upon all available environment stimuli to determine if the event is a threat or non-threatening.
c. The system must alarm to a human element, on or off-site, visually and/or audibly.
d. The system must log all events (threat and non-threat) and maintain the log for at least 10 calendar days.
e. The system must have a Nuisance Alarm Rate (NAR) and False Alarm Rate (FAR) of less than 10%.

Next the assessor moves onto the IKE certification process and related scoring as follows, 310-350.

a. Point values for AOI Connectivity are as follows:
i. Connected to Lighting-Perimeter 0.75, Area 0.75, Shock 0.75
ii. Connected to ESS-Fence 2, Line of Sight 2, Buried 2, Acoustic 2.
   iii. Connected to Cameras-Perimeter 2, Area 2
      b. A 50% point addition to the point value in Scoring Step a above, will be assessed for a system that is predictive in nature (e.g. automatically directs cameras and sensors toward the threat based upon speed and direction).
      c. A 50% point addition to the point value in Scoring Step a above, will be assessed for a system that alarms to a map (e.g. automatically indicates on an electronic map the location and direction of travel of a threat.)
      d. A 50% point reduction penalty will be assessed for any system that does not product a visible or audible alarm either on-site or remotely (e.g. only logs the event).
      e. A 50% point reduction penalty will be assessed for any system that does not log a security event or maintains the log for less than 10 calendar days.
      f. A 50% point reduction penalty will be assessed for any system that has a NAR/FAR of 10% or greater.
      g. The total point value will not be reduced further than zero.

The last component of the AAS assessment 270 is the Assessment of bandwidth and playback. This is defined as the Assessment of a system capability to transmit the spectrum of security information to a remote site for appraisal, categorization of threat, and security response.

The assessor assesses that the following requirements are met for such a system:

a. Analytics system must be automated to report an alarm to an off-site/remote station.
b. Bandwidth must be sufficient to transmit at least two simultaneous video feeds to an off-site or remote viewing platform.
c. Full playback is defined as 1080p full-resolution at 30 frames per second (FPS).

Next the assessor moves onto the IKE certification process and related scoring as follows 310-350.

Point values for Bandwidth and Notification characteristics are as follows:

a. Notification Method—cellular Dialer (text message only) 3, buried cable or Fiber Optic 8,
b. Notification Enhancements-Automated Bandwidth Adjustment 3, Transmit AOI info 5.

Point values for Playback Characteristics are as follows:

a. Number of simultaneous feeds—1 feed: 3, 2 Feeds: 4, 3 or 4 feeds: 5, 5 or more feeds: 6
b. Resolution—1080P or higher:4, 740p to 1080p:3, Less than 740p:2
c. Frames per Second (FPS)—30 FPS: 4, 15 to 29 FPS:3.6, 11 to 15 FPS:3, 3 to 10 FPS: 2, 2 or less FPS: 0

Once all the individual scoring for each and every component is gathered, the assessor then compiles a final tally of the score 360, FIG. 3. This final tally for each of the aspects of security, allows the removal of the subjectivity out of scoring, and accords a standardized computation to the score by which it can be determined if security requirements are being met or falling short of a desired standard. Once the final score has been accorded to all components, then the assessor then does an internal assessment 370, to make a determination how far from an ‘ideal’ IKE score the system is and what additions need to be made to achieve this score.

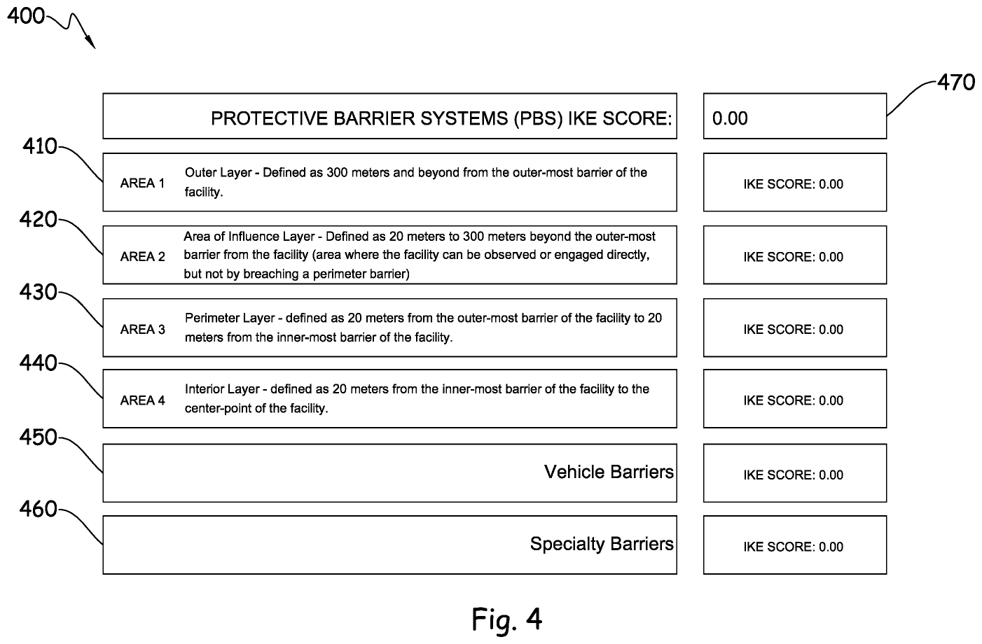

FIG. 4 is an example embodiment of one aspect of the invention, wherein it is shown how the over-all score is computed for the protective barrier system 400. In this embodiment all the individual component score are first gathered and inputted into the spread sheet as defined by Areas 1, 2, 3, 4, vehicle barriers and specialty barriers, in 410-460.

a. Area 1, 410 is the outer layer defined as 300 meters and beyond from the outer most barrier of the facility.
b. Area 2, 420 is the area of influence-defined as 20 meters to 300 meters beyond the outer most barrier from the facility (area where the facility can be observed or engaged directly, but not be breaching a perimeter barrier).
c. Area 3, 430 is the perimeter layer-defined as 20 meters from the outer most barrier of the facility.
d. Area 4, 440 is the interior layer-defined as 20 meters from the inner most barrier of the facility to the center point of the facility.

These areas, have been scored above as PBS area scoring in the description laid forth above,

Vehicle barriers and specialty barrier scoring 450-460 is also described more in detail above. The computation of the total score 470, allows a person to see the sum total of protective barrier system (PBS) score, and hence get a good determination of the deviation of the score from a desired IKE score.

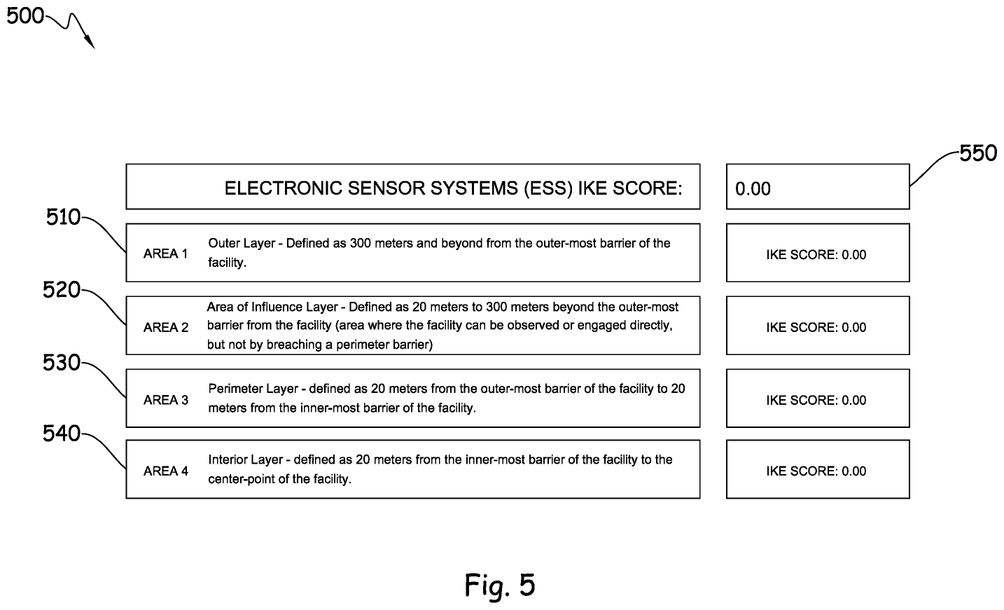

Similarly, FIG. 5 is an example embodiment of another aspect of the invention wherein the over-all score is computed for the Electronic sensor systems (ESS) 500. Again, in this embodiment all the individual component scores are first determined, as described in detail above, and inputted into a spread sheet as defined by areas 1, 2, 3 and 4, 510-540. By computing the individual scores the sum total for the electronic sensors is then derived 550, to give an idea of how near or far the total score is from a preferred IKE score for electronic sensors.

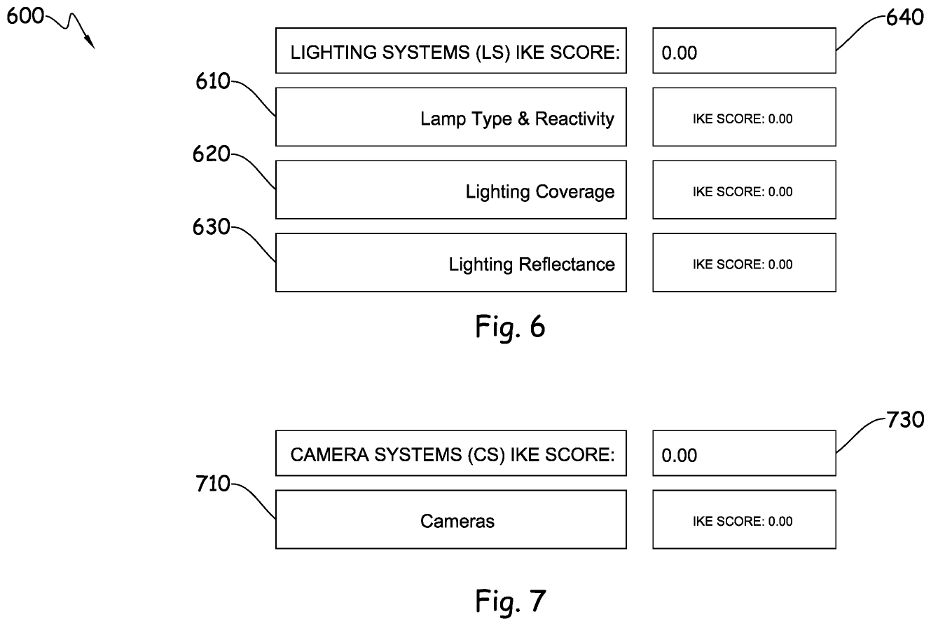

FIG. 6 depicts another example embodiment of the invention wherein the over-all score is computed for the lighting systems (LS) 600. The individual score of the lamp type and reactivity 610, lighting coverage 620, facility reflectance 630 are first computed, as described in detail above. The final sum total score is then determined 640 to give an idea of the deviation from a preferred IKE score for the lighting system.

FIG. 7 depicts an example embodiment of the invention wherein the overall score is computed for the camera system (CS) 700. The individual score of cameras is first computed 710. The final sum total score is then determined 730 to give an idea of the deviation from a preferred IKE score for the camera system.

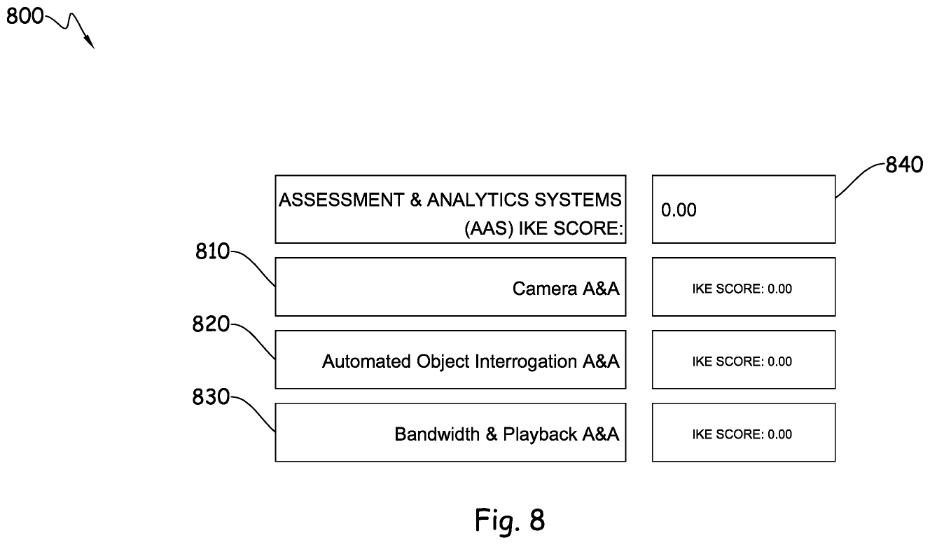

FIG. 8 depicts an example embodiment of the invention wherein the over-all score is computed for the assessment and analytics system (AAS) 800. The individual score of the Cameras A&A 810, Automated Object interrogation A&A 820, Bandwidth &Playback A&A 830 are first computed, as described in detail above. The final sum total score is then determined 840 to give an idea of the deviation from a preferred IKE total score for the Assessment and Analytics system.

Once the sum total of all individual components are received an internal analysis is then conducted to review the findings, step 5 (150 in FIG. 1 and step 5 (370) in FIG. 3). This internal analysis allows the certification professional to come up with an analysis of what needs to be added to the system to be able to have the overall system better comply with the IKE certification requirements and to also be able to present to the owner the shortcoming that need to be addressed.

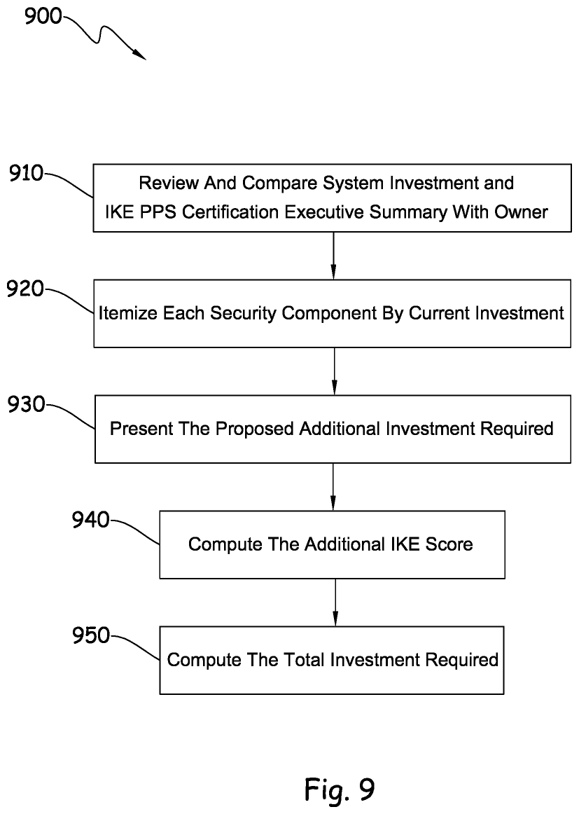

Moving onto FIG. 9, another flow chart depicting the next steps of the over-all process are shown 900. Once the IKE certification process is completed, there is the need to provide the recommended security solutions and countermeasures, so they can be reviewed and possibly implemented by the customer. These recommended security solutions and the IKE results are included in a written report that documents the overall IKE analysis.

The next phase in the process is now a meeting with the owner to determine the findings and do a gap analysis and present a gap closure strategy. Herein each and every component with its individual IKE score as well as sum total of the IKE score is described in detail. Furthermore, each and every component as depicted in FIGS. 4-9 is itemized according to the current investment that has been input 920, and what additional investment would be needed for a best possible return on investment 930. It will be further determined what additional IKE score is required to achieve this best possible return on investment 940. Finally, it is determined what the total investment would be to reach the desired goal of best possible ROI and this would be the gap closure strategy 950.

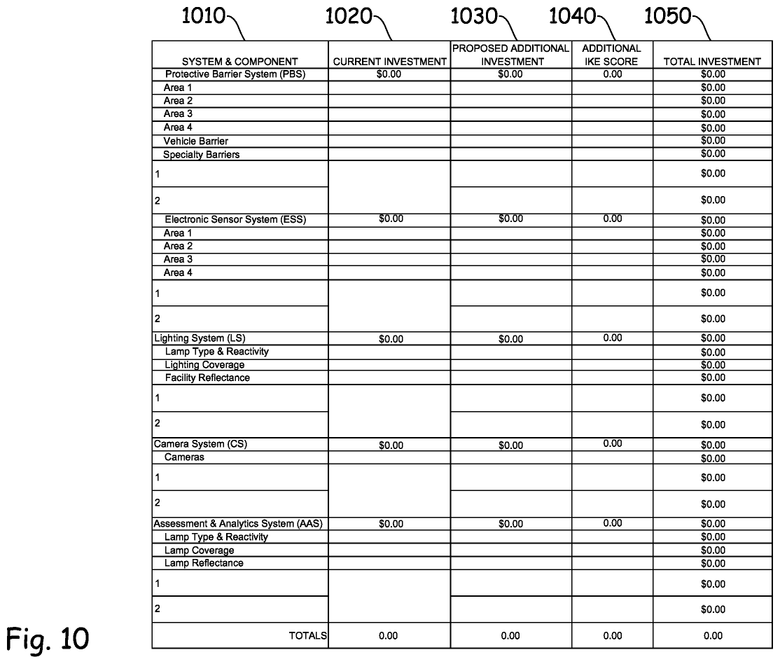

An example embodiment of such a presentation with the owner is shown in FIG. 10, wherein the system and components are first individually set forth 1010, the current investment for each component is itemized 1020, the proposed initial investment is projected 1030, the additional IKE score to reach this proposed investment is determined 1040 and finally the total investment required to achieve the desired result is put forth 1050.

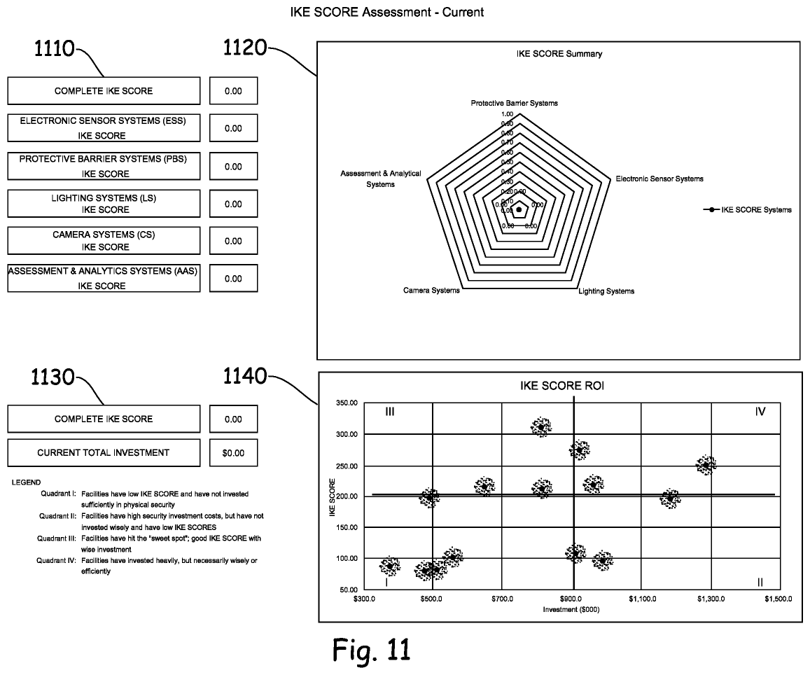

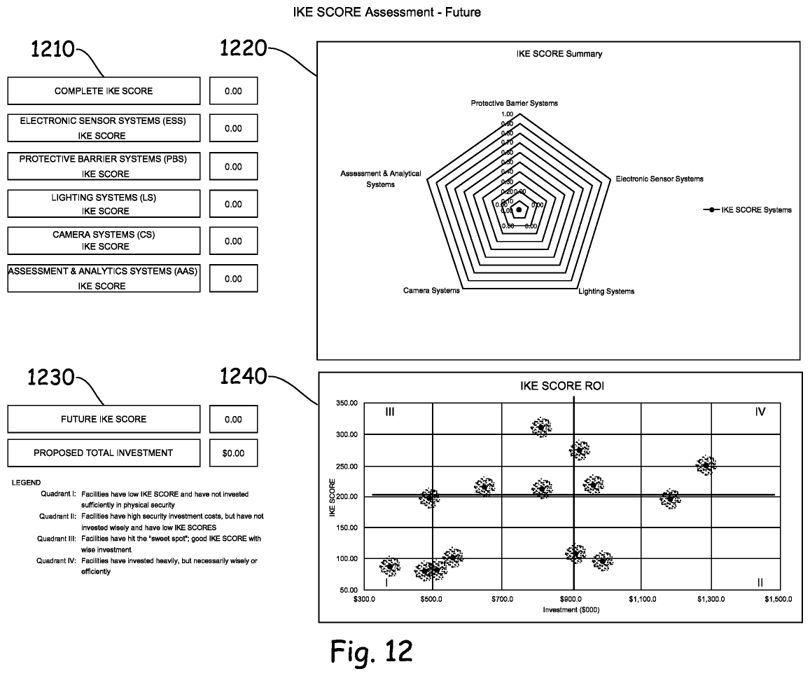

Further breakdown of the client's current and future IKE scores and total investment can be presented in the form of FIGS. 11 and 12.

FIG. 11 displays an example embodiment of the invention with a current score analysis and corresponding chart area where the owner's physical systems currently reside. As indicated in 1110, the complete IKE score along with the breakdown for each aspect is listed individually. 1120 displays an IKE score summary of each aspect of the invention, the PBS, ESS, LS CS and AAS. At each corner of the pentagon is projected a security component, and the current deviation is listed, with 0 being worst and 1.0 being the best score. The further away from the center or 0 the score is for each component, the more secure the system is.

1130 lists the complete IKE score as well as the current total investment made in the system presently. 1140 shows the present investment with the IKE score in the form of a quadrant. Quadrant I indicates facilities have low IKE scores and have not sufficiently invested in physical security. Quadrant II shows facilities have high security investment cots, but have not invested wisely and have low IKE scores. Quadrant III are facilities that have a good IKE score with good investment. Quadrant IV have invested heavily, but necessarily wisely or efficiently. An owner would ideally want to be situated in Quadrant III as shown in 1140, to have the best return on their investment (ROI).

FIG. 12 displays an example embodiment of the invention with a future score analysis and corresponding chart area of the owner's physical systems. As indicated in 1210, the complete future IKE score along with the breakdown for each aspect i.e. Protective Barrier Systems, Electronic Sensor Systems, Lighting Systems, Camera Systems, Assessment and Analytics Systems, are listed individually. 1220 displays an IKE score summary of each security component of the invention, the PBS, ESS, LS CS and AAS. At each corner of the pentagon is projected a security component, and the current deviation is listed with 0 being worst and 1.0 being the best score. The further away from the center or 0 the score is for each component of security the more secure the system is. Ideally with this future projection the score would want to be as close to 1.0 as possible, but anything above 0.8 would be considered a good score.

1230 lists the complete future IKE score as well as the proposed total investment that needs to be made to reach this IKE score.

This future IKE score would be the best possible score to make the system as secure as possible. 1240 shows the present investment with the IKE score in the form of a quadrant. Quadrant I indicates facilities have low IKE scores and have not sufficiently invested in physical security. Quadrant II shows facilities have high security investment cots, but have not invested wisely and have low IKE scores. Quadrant III are facilities that have a good IKE score with good investment. Quadrant IV have invested heavily, but not necessarily wisely or efficiently. With the future IKE score and the proposed initial investment, the aim of the IKE personnel is to be able to allow the owner to be situated in quadrant III so as to be able to get the best possible return on their investment with regards to security.

While the best modes for carrying out the invention have been described in detail, those familiar with the art to which this invention relates will recognize various alternative designs and embodiments for practicing the invention within the scope of the appended claims.

What is claimed is:

1. A method for analyzing a security risk of one or more assets within a infrastructure comprising the steps of:
Analyzing a security asset of the infrastructure;
Calculating a IKE score for an asset based on certain pre-defined criteria;
Determining the security risk of one or more of the assets based on the IKE score;
Performing a gap analysis to minimize the risk of one or more of the assets; and
Presenting the gap analysis to an owner of the infrastructure.

2. The method of claim 1, wherein analyzing the security asset consists of analyzing a perimeter, a barrier, a electronic sensor system, a lightning system, a camera system, and a assessment system.

3. The method of claim 2, wherein the IKE score is computed for each of the security assets.

4. The method of claim 3, wherein a overall score is computed for each of the security assets.

5. The method of claim 4, wherein the IKE score and the overall scored of each of the security assets are presented to the owner of the infrastructure.

6. The method of claim 1, further comprising a present return of investment of the infrastructure.

7. The method of claim 1, further comprising a future return of investment of the infrastructure.
